(19) United States
(12) Patent Application Publication
(10) Pub. No.: US 2015/0142960 A1
(43) Pub. Date: May 21, 2015

(54) INFORMATION PROCESSING APPARATUS, INFORMATION PROCESSING METHOD AND INFORMATION PROCESSING SYSTEM

(71) Applicant: FUJITSU LIMITED, Kawasaki-shi (JP)

(72) Inventor: Toshikazu UCHIYAMA, Kawasaki (JP)

(73) Assignee: FUJITSU LIMITED, Kawasaki-shi (JP)

(21) Appl. No.: 14/484,834

(22) Filed: Sep. 12, 2014

(30) Foreign Application Priority Data
Nov. 21, 2013 (JP) 2013-240518

(51) Int. Cl. H04L 29/12

(52) U.S. Cl. CPC H04L 61/2076; H04L 61/2015
USPC 709/224

(57) ABSTRACT

An information processing apparatus includes a memory, and a processor coupled to the memory and configured to acquire a first identifier indicating a device coupled to a network at a first time point, acquire a second identifier indicating a device coupled to the network at a second time point after the first time point, and determine whether or not the second identifier is identical to the first identifier.

### CROSS-REFERENCE TO RELATED APPLICATION

This application is based upon and claims the benefit of priority of the prior Japanese Patent Application No. 2013-240518, filed on Nov. 21, 2013, the entire contents of which are incorporated herein by reference.

### FIELD

The embodiments discussed herein are related to a technique to manage devices coupled to a network.

### BACKGROUND

Various kinds of devices such as a server, a network device such as a local area network (LAN) switch, for example, and a storage device are coupled to a network built in an office or the like. A management apparatus to manage the devices coupled to the network is also coupled to the network, and performs management work such as monitoring of failures that may occur in the devices.

When a device is newly coupled to the network, a network administrator or the like can set the newly coupled device as a device to be managed by performing a setting operation on the management apparatus. However, if the number of devices coupled to the network is very large, for example, several hundred or more, the setting operation places a burden on the administrator.

Regarding such a problem, the following technique has been proposed. To be more specific, a Dynamic Host Configuration Protocol (DHCP) server in a network stores access information for a device management server configured to manage multifunction peripheral (MFP) devices coupled to the network. Each of the MFP devices sends the DHCP server a message to request acquisition of the access information, and acquires the access information from a message received from the DHCP server. Then, the MFP device sends the device management server device information unique to the MFP device by using the acquired access information, and sends the device management server device information indicating the state of the MFP device in response to a connection approval message from the device management server.

However, in the conventional technique described above, the new technique is introduced into all of the DHCP server, the device management server and the MFP device. Therefore, in the case of building a system using the above conventional technique, all of the DHCP server, the device management server and the MFP device are modified or replaced with dedicated ones. Examples of related prior art documents include Japanese Laid-open Patent Publication No. 2011-165048.

### SUMMARY

According to an aspect of the invention, an information processing apparatus includes a memory, and a processor coupled to the memory and configured to acquire a first identifier indicating a device coupled to a network at a first time point, acquire a second identifier indicating a device coupled to the network at a second time point after the first time point, and determine whether or not the second identifier is identical to the first identifier.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an overview of a system according to a first embodiment;

FIG. 2 is a functional block diagram of a management server according to the first embodiment;

FIG. 3 is a table illustrating an example of data stored in an assigned address storage unit;

FIG. 4 is a flowchart illustrating a main processing flow according to the first embodiment;

FIG. 5 is a table illustrating an example of an assigned address list;

FIG. 6 is a table illustrating an example of a checked address list;

FIG. 7 is a table illustrating an example of the checked address list;

FIG. 8 is a flowchart illustrating a processing flow of check processing;

FIG. 9 is a table illustrating an example of a management target address list;

FIG. 10 is a table illustrating an example of the management target address list;

FIG. 11 is a table illustrating an example of the management target address list;

FIG. 12 is a table illustrating an example of the management target address list;

FIG. 13 is a functional block diagram of a management server according to a second embodiment;

FIG. 14 is a table illustrating an example of a checked address list;

FIG. 15 is a flowchart illustrating a main processing flow according to the second embodiment;

FIG. 16 is a table illustrating an example of the checked address list;

FIG. 17 is a table illustrating an example of the checked address list;

FIG. 18 is a table illustrating an example of the checked address list;

FIG. 19 is a table illustrating an example of a list stored in an operation list storage unit;

FIG. 20 is a table illustrating an example of the checked address list;

FIG. 21 is a flowchart illustrating a main processing flow according to a third embodiment;

FIG. 22 is a table illustrating an example of a checked address list;

FIG. 23 is a table illustrating an example of the checked address list;

FIG. 24 is a table illustrating an example of the checked address list;

FIG. 25 is a table illustrating an example of the checked address list; and

FIG. 26 is a functional block diagram of a computer.

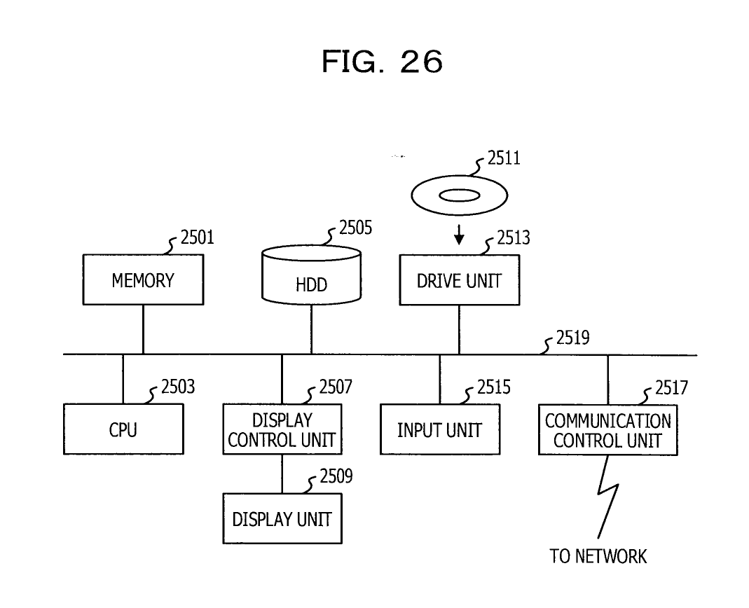

### DESCRIPTION OF EMBODIMENTS

### Embodiment 1

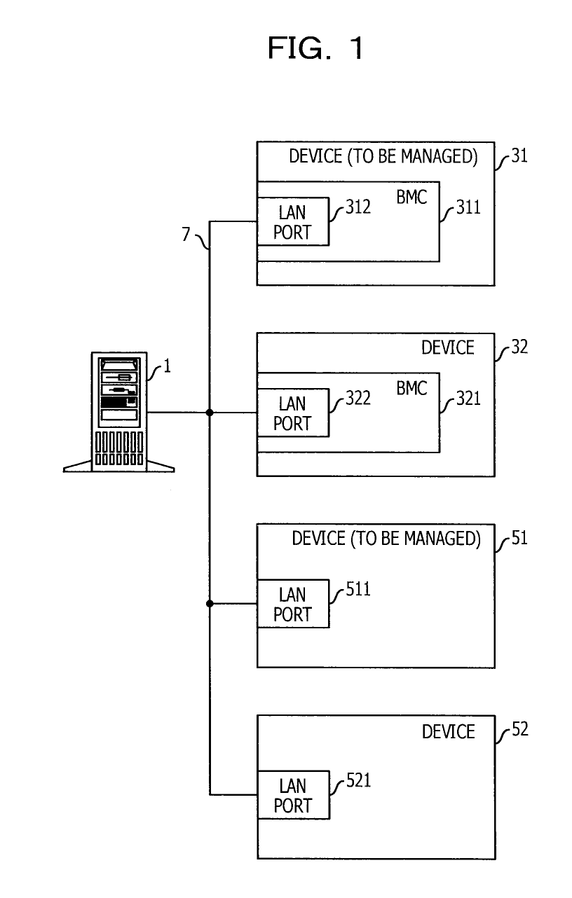

FIG. 1 illustrates an overview of a system according to this embodiment. A device 31 and a device 32, which are servers, and a device 51 and a device 52, which are devices other than servers, for example, a network switch, a storage device or the like, are coupled to a management server 1 configured to execute main processing of this embodiment, through a network 7 that is a LAN. The device 31 includes a Baseboard Management Controller (BMC) 311 with a LAN port 312, and the device 32 includes a BMC 321 with a LAN port 322. The device 31 is coupled to the network 7 through the LAN port 312, and the device 32 is coupled to the network 7 through the LAN port 322. The device 51 includes a LAN port 511 and is coupled to the network 7 through the LAN port 511. The device 52 includes a LAN port 521 and is coupled to the network 7 through the LAN port 521.

The BMC 311 and the BMC 321 are compatible with an Intelligent Platform Management Interface (IPMI). The management server 1 can perform remote control and management of the devices 31 and 32 through the BMCs 311 and 321. The devices 51 and 52 can communicate with the management server 1 by using a Telecommunication Network (Telnet), a Simple Network Management Protocol (SNMP) or the like. The device 31 and the device 51 are to be managed by the management server 1, while the device 32 and the device 52 are not to be managed by the management server 1. Although both the number of devices to be managed and the number of devices not to be managed are two in FIG. 1, the numbers thereof are not limited thereto. It depends on the management server 1 whether or not the devices are to be managed.

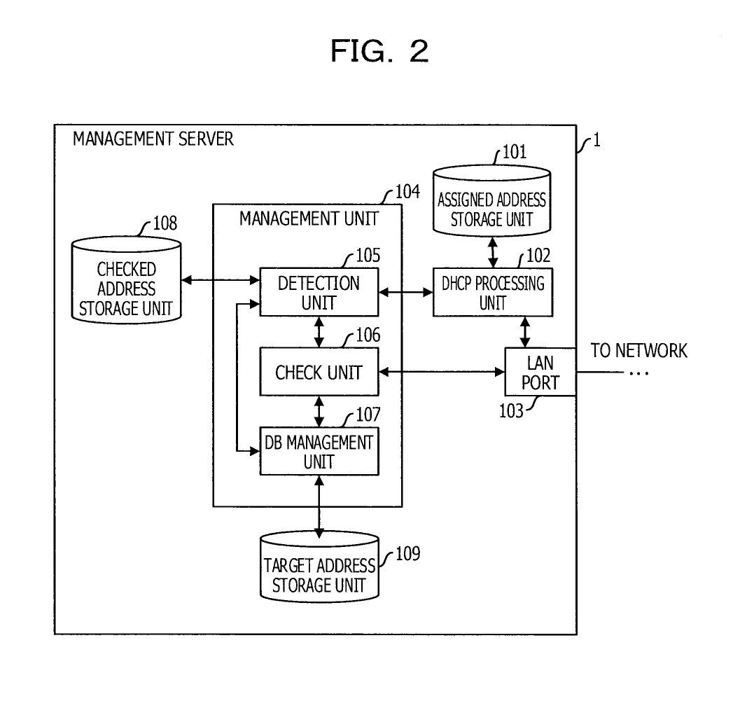

FIG. 2 illustrates a functional block diagram of the management server 1. The management server 1 includes an assigned address storage unit 101, a DHCP processing unit 102, a LAN port 103, a management unit 104 including a detection unit 105, a check unit 106 and a DB management unit 107, a checked address storage unit 108 and a target address storage unit 109.

The management server 1 is coupled to the network 7 through the LAN port 103. The DHCP processing unit 102 executes processing to assign Internet Protocol (IP) addresses to the devices coupled to the network 7.

The DHCP processing unit 102 is typically on. When a new device is coupled to the network 7 and the device is powered on, the device requests the DHCP processing unit 102 to assign an IP address thereto. Upon receipt of the request, the DHCP processing unit 102 assigns an IP address to the device and stores the assigned IP address in the assigned address storage unit 101. Meanwhile, when the device is uncoupled from the network 7, the device no longer makes an IP address request to the DHCP processing unit 102. Therefore, the DHCP processing unit 102 deletes the IP address assigned to the device from the assigned address storage unit 101.

The detection unit 105 periodically, for example, requests the DHCP processing unit 102 for an assigned address list, and acquires the assigned address list from the DHCP processing unit 102. The detection unit 105 executes processing of detecting a device newly coupled to the network 7, and the like, based on the assigned address list acquired from the DHCP processing unit 102 and a checked address list stored in the checked address storage unit 108. Upon detection of the device newly coupled to the network 7, the detection unit 105 instructs the check unit 106 to execute check processing.

The check unit 106 communicates with the device newly coupled to the network 7, and determines whether or not the device is to be managed by the management server 1. When the device is determined to be managed by the management server 1, the check unit 106 outputs an IP address and a Media Access Control (MAC) address of the device to the DB management unit 107.

The DB management unit 107 stores the IP address and MAC address received from the check unit 106 in the target address storage unit 109 configured to store addresses of devices to be managed.

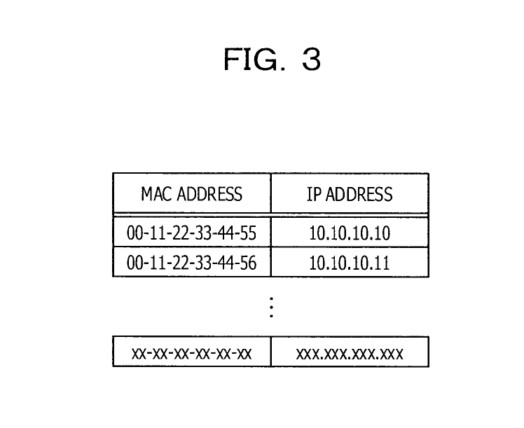

FIG. 3 illustrates an example of an assigned address list stored in the assigned address storage unit 101. In the example illustrated in FIG. 3, MAC addresses and IP addresses are stored. The IP addresses are those assigned to the devices coupled to the network 7, and the MAC addresses are those of the devices.

A format of the list stored in the checked address storage unit 108 and a format of the list stored in the target address storage unit 109 are the same as that of the list stored in the assigned address storage unit 101. However, in the initial stage, no checked addresses are stored in the checked address storage unit 108.

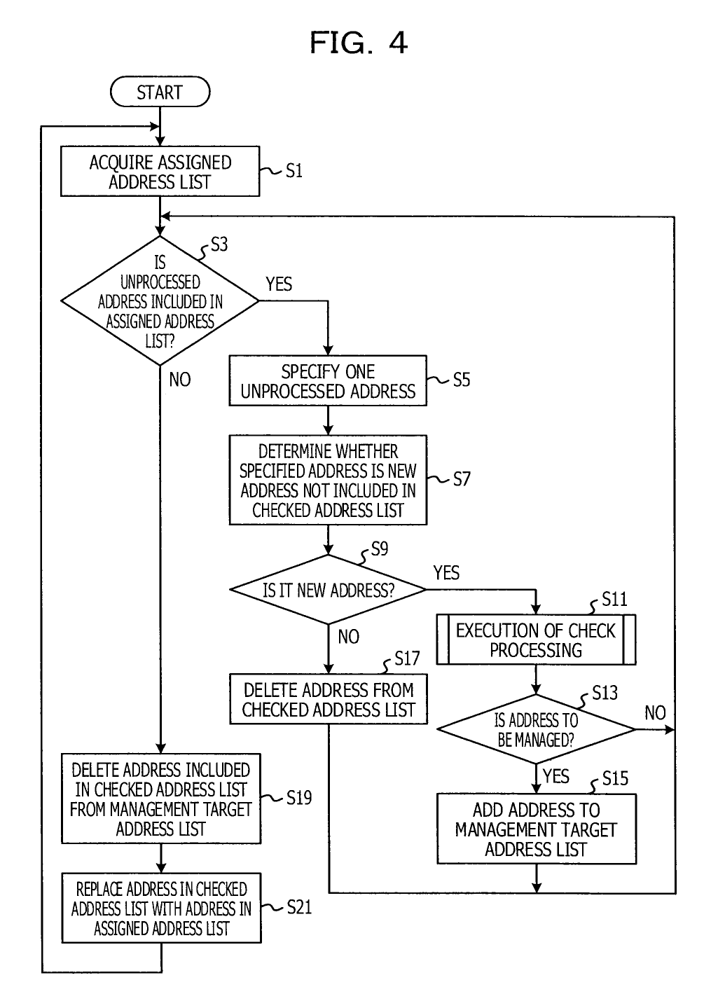

Next, with reference to FIGS. 4 to 12, description is given of processing executed by the management server 1. First, the detection unit 105 requests the DHCP processing unit 102 for an assigned address list periodically, for example, once every second. Then, the detection unit 105 acquires the assigned address list from the DHCP processing unit 102 (FIG. 4: Step S1).

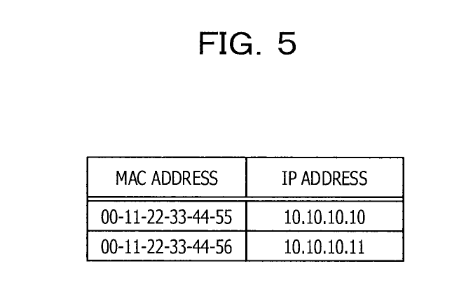

Here, it is assumed that an assigned address list stored in the assigned address storage unit 101 at the time point of Step S1 is a list illustrated in FIG. 5, for example. More specifically, it is assumed that two devices are coupled to the network 7. Hereinafter, for convenience of explanation, a device having a MAC address “00-11-22-33-44-55” and an IP address “10.10.10.10” is referred to as a device A, while a device having a MAC address “00-11-22-33-44-56” and an IP address “10.10.10.11” is referred to as a device B.

The detection unit 105 determines whether or not the assigned address list includes an unprocessed address (Step S3). Note that, when the processing of Step S3 is executed for the first time, the assigned address list does not include any processed address. Also, the “address” in this processing means a set of a MAC address and an IP address.

When there are unprocessed addresses (Step S3: Yes route), the detection unit 105 specifies one unprocessed address (Step S5). Then, the detection unit 105 determines whether or not the specified address is a new address that is not included in a checked address list, that is, a list of addresses stored in the checked address storage unit 108 (Step S7). The address not included in the checked address list is an address of a device newly coupled to the network 7, which is a new address. Note that, when the processing of Step S7 is executed for the first time, no addresses are included in the checked address list. Therefore, all the addresses in the assigned address list are new addresses.

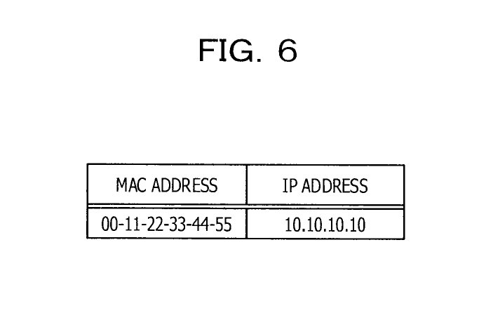

Here, it is assumed that a checked address list stored in the checked address storage unit 108 at the time point of Step S9 is a list illustrated in FIG. 6. More specifically, it is assumed that the address of the device A is stored in the checked address storage unit 108. In this case, the address of the device A from the two addresses illustrated in FIG. 5 is determined not to be a new address, and the address of the device B is determined to be a new address.

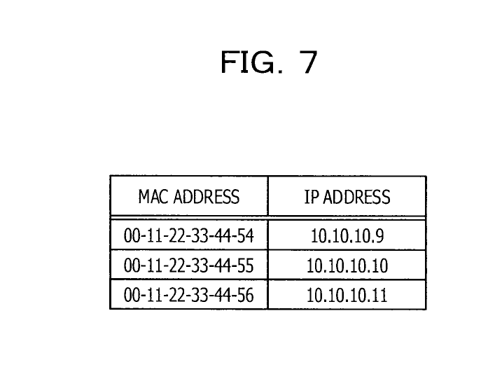

Note that, as described later, an assigned address list previously acquired is stored in the checked address storage unit 108. It is assumed that a list illustrated in FIG. 7 is stored in the checked address storage unit 108. More specifically, it is assumed that an address of a device (hereinafter referred to as a device C) having a MAC address “00-11-22-33-44-54” and an IP address “10.10.10.9”, the address of the device A and the address of the device B are stored. Also, an assigned address list acquired this time is the list illustrated in FIG. 5. In such a case, the device C is uncoupled from the network 7, while the devices A and B stay coupled to the network 7.

Referring back to FIG. 4, when the specified address is not a new address (Step S9: No route), the detection unit 105 deletes the address specified in Step S7 from the checked address list (Step S17). By this processing, the address of the device uncoupled from the network 7 remains in the checked address list.

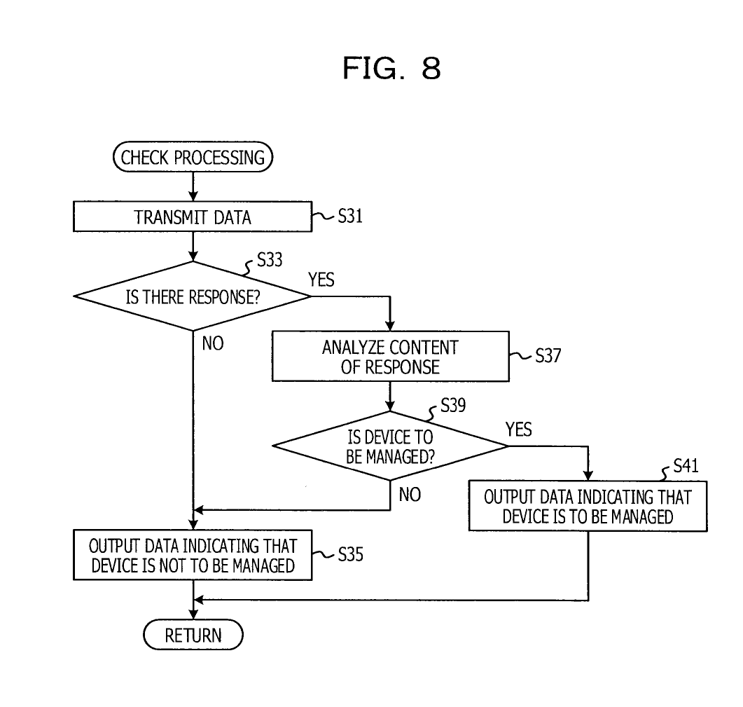

On the other hand, when the specified address is a new address (Step S9: Yes route), the detection unit 105 instructs the check unit 106 to execute check processing. In response to this instruction, the check unit 106 executes the check processing (Step S11). The check processing is described with reference to FIG. 8.

First, the check unit 106 transmits data to the device having the address specified in Step S5 (FIG. 8: Step S31). When the destination is a server, the transmitted data is an IPMI command, for example, a get Field Replaceable Unit (FRU) command. Meanwhile, when the destination is a device other than the server, the transmitted data is Telnet or SNMP data.

The check unit 106 determines whether or not there is a response to the data transmitted in Step S31 (Step S33). When there is no response (Step S33: No route), the check unit 106 outputs data to the detection unit 105, the data indicating that the device is not to be managed (Step S35).

On the other hand, when there is a response (Step S33: Yes route), the check unit 106 analyzes a content of the response (Step S37). The response includes a product name, for example. The check unit 106 can check, based on the product name, whether or not the device is to be managed.

When the destination device is not to be managed (Step S39: No route), the processing moves to Step S35. On the other hand, when the destination device is to be managed (Step S39: Yes route), the check unit 106 outputs data to the detection unit 105, the data indicating that the device is to be managed (Step S41). Then, the processing returns to that of the invoker.

The execution of such processing enables determination of whether or not the device newly coupled to the network 7 is to be managed.

Referring back to FIG. 4, based on the result of the check processing, the detection unit 105 determines whether or not the device having the address specified in Step S5 is to be managed (Step S13). When the device is not to be managed (Step S13: No route), the processing returns to Step S3 for processing of the next address.

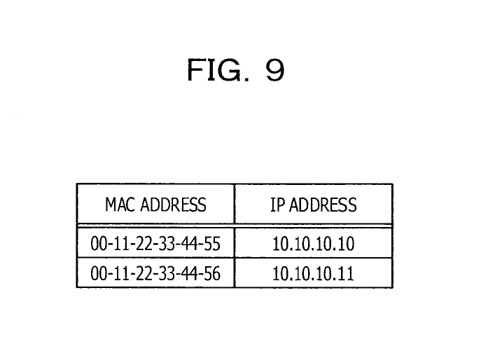

On the other hand, when the device is to be managed (Step S13: Yes route), the detection unit 105 outputs the address specified in Step S5 to the DB management unit 107. Upon receipt of the specified address, the DB management unit 107 adds the received address to a management target address list stored in the target address storage unit 109 (Step S15). Then, the processing returns to Step S3. A list illustrated in FIG. 9, for example, is stored in the target address storage unit 109. In the example illustrated in FIG. 9, a list including the address of the device A and the address of the device B is stored.

When it is determined in Step S3 that the assigned address list includes no unprocessed address (Step S3: No route), the detection unit 105 deletes an address, included in both the management target address list and the checked address list, from the management target address list (Step S19).

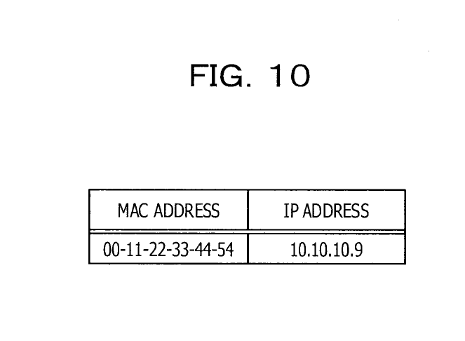

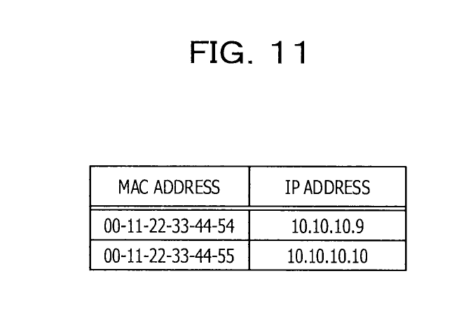

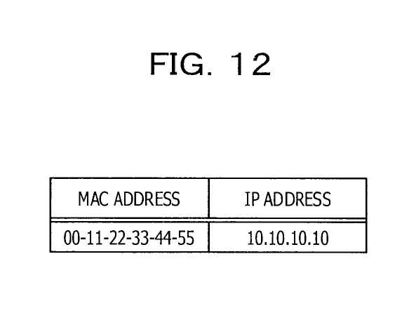

A specific example for the case where the No route is taken in Step S3 is provided herein. For example, it is assumed that the address stored in the checked address storage unit 108 is the address of the device C as illustrated in FIG. 10; and also that the management target address list in the target address storage unit 109 before execution of processing in Step S19 includes the address of the device C and the address of the device A as illustrated in FIG. 11. Then, after the processing of Step S19, the management target address list becomes one illustrated in FIG. 12. In other words, only the address of the device A is included in the management target address list.

Referring back to FIG. 4, the detection unit 105 replaces the address included in the checked address list with the address included in the assigned address list (Step S21), and stores the address in the checked address storage unit 108. Then, the processing returns to Step S1. As described above, the assigned address list acquired this time is used as the checked address list next time. Thus, in this embodiment, lists of assigned addresses can be acquired at multiple time points, and the acquired lists can be compared with each other.

The execution of the processing as described above enables simple detection of a device newly coupled to the network 7 without introducing a special mechanism into the device. Thus, in the case of application of this embodiment, only replacement with the management server 1 described above is desired.

Moreover, the management server 1 can automatically detect a device when the device is coupled to the network 7. Therefore, a network administrator or the like who operates the management server 1 does not have to search for the newly coupled device by inputting an IP address and the like. Thus, costs can be reduced.

### Embodiment 2

Next, a second embodiment is described. In the first embodiment, the detection unit 105 uses the set of IP address and MAC address for the processing. However, in this case, since the processing of searching through the list is performed for both of the IP address and the MAC address, the processing may take time. Therefore, in the second embodiment, a key is associated with a set of an IP address and a MAC address for use in processing by the detection unit 105.

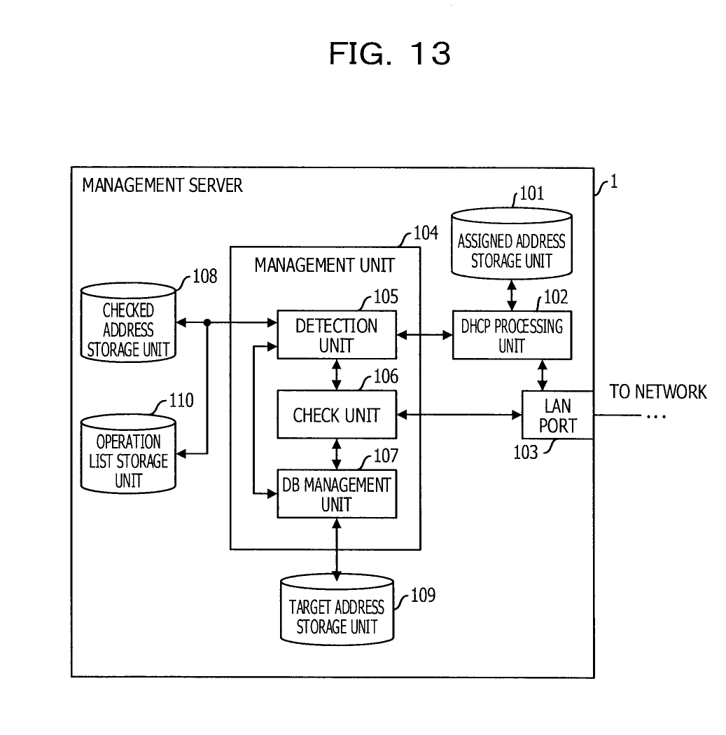

FIG. 13 illustrates a functional block diagram of a management server. In the example illustrated in FIG. 13, a management server 1 includes an assigned address storage unit 101, a DHCP processing unit 102, a LAN port 103, a management unit 104 including a detection unit 105, a check unit 106 and a DB management unit 107, a checked address storage unit 108, a target address storage unit 109 and an operation list storage unit 110. The management server 1 according to the second embodiment is different from the management server 1 according to the first embodiment in including the operation list storage unit 110.

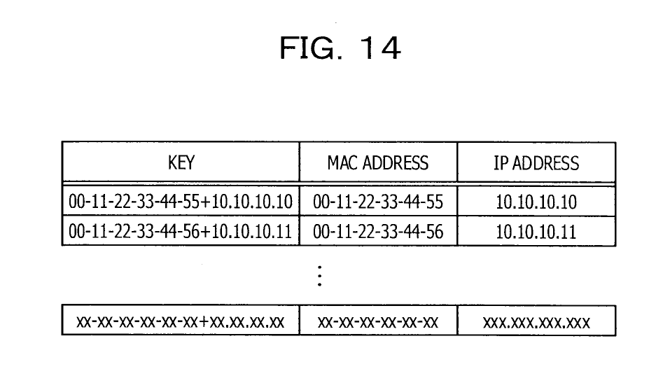

FIG. 14 illustrates an example of a list stored in the checked address storage unit 108. In the example illustrated in FIG. 14, a key including a MAC address and an IP address, the MAC address and the IP address are stored. The key is generated from the MAC address and the IP address. Note that other data to be used by the management unit 104 may be further stored. However, in the initial stage, no list is stored in the checked address storage unit 108.

A format of a list stored in the operation list storage unit 110 is the same as that of the list stored in the checked address storage unit 108.

A format of a list stored in the assigned address storage unit 101 and a format of a list stored in the target address storage unit 109 are the same as that of the list stored in the assigned address storage unit 101 according to the first embodiment.

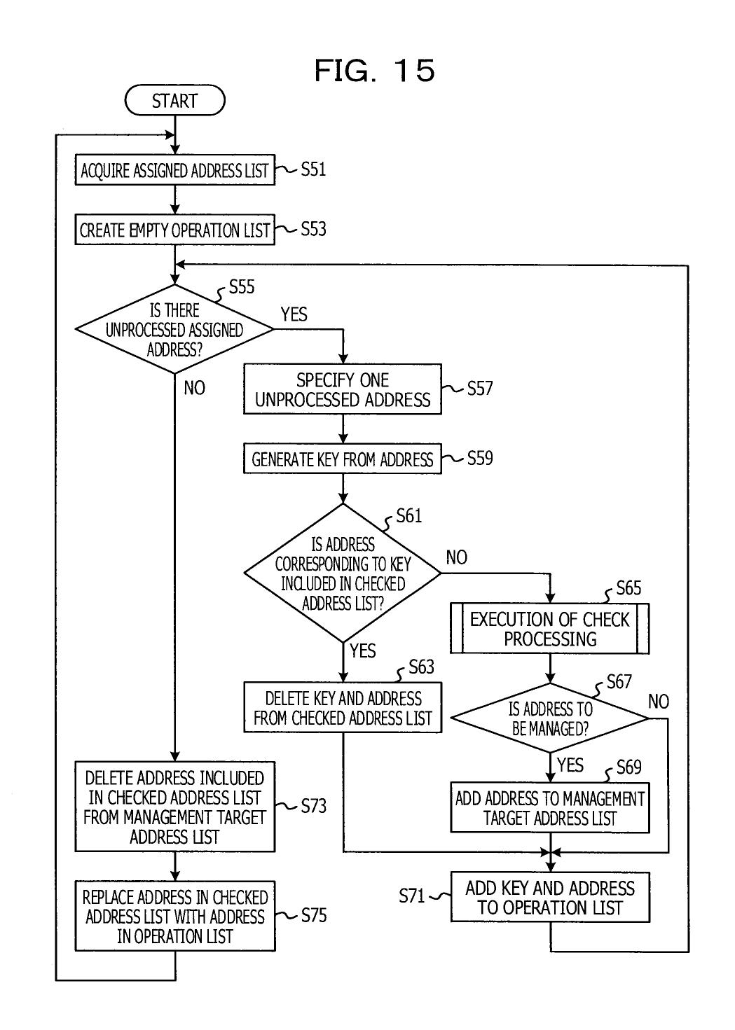

Next, with reference to FIGS. 15 to 19, description is given of processing executed by the management server 1. First, the detection unit 105 requests the DHCP processing unit 102 for an assigned address list periodically, for example, once every second. Then, the detection unit 105 acquires the assigned address list from the DHCP processing unit 102 (FIG. 15: Step S51). The assigned address list acquired in Step S51 is the list illustrated in FIG. 5, for example.

The detection unit 105 generates an empty operation list and stores the generated operation list in the operation list storage unit 110 (Step S53).

The detection unit 105 determines whether or not the assigned address list includes an unprocessed address (Step S55). Note that, when the processing of Step S55 is executed for the first time, the assigned address list includes no processed addresses. Also, the “address” in this processing means a set of a MAC address and an IP address.

When there are unprocessed addresses (Step S55: Yes route), the detection unit 105 specifies one unprocessed address (Step S57). Then, the detection unit 105 generates a key from a MAC address and an IP address, which are included in the specified address (Step S59). The key is generated by connecting the MAC address and the IP address, for example.

The detection unit 105 determines whether or not the address corresponding to the key generated in Step S59 is included in a checked address list (Step S61). The address not included in the checked address list is an address of a device newly coupled to the network 7, which is a new address. Note that, when the processing of Step S61 is executed for the first time, no addresses are included in the checked address list.

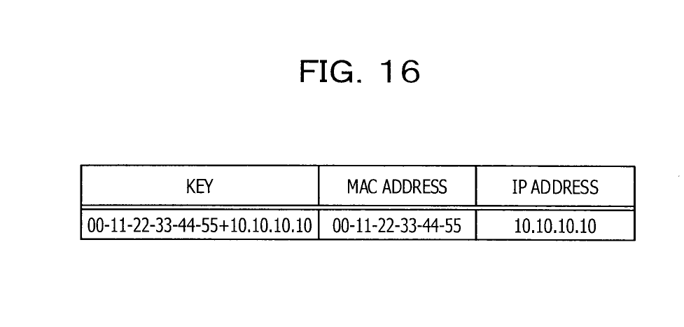

Here, it is assumed that a checked address list stored in the checked address storage unit 108 at the time point of Step S61 is a list illustrated in FIG. 16. More specifically, it is assumed that the key and address of the device A are stored in the checked address storage unit 108. In this case, the address of the device A from the two addresses illustrated in FIG. 5 is determined not to be a new address, and the address of the device B is determined to be a new address.

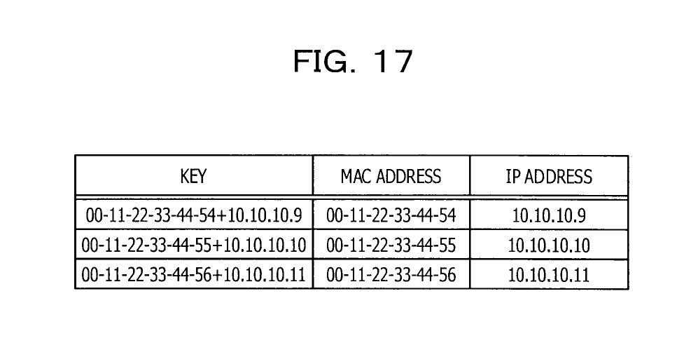

Also, it is assumed that a list illustrated in FIG. 17 is stored in the checked address storage unit 108. More specifically, it is assumed that the key and address of the device C, the key and address of the device A and the key and address of the device B are stored. It is also assumed that an assigned address list acquired this time is the list illustrated in FIG. 5. In this case, the device C is uncoupled from the network 7, while the devices A and B stay coupled to the network 7.

Referring back to FIG. 15, when the address corresponding to the key generated in Step S59 is included in the checked address list (Step S61: Yes route), the detection unit 105 deletes the key generated in Step S59 and the address specified in Step S57 from the checked address list (Step S63). Then, the processing moves to Step S71.

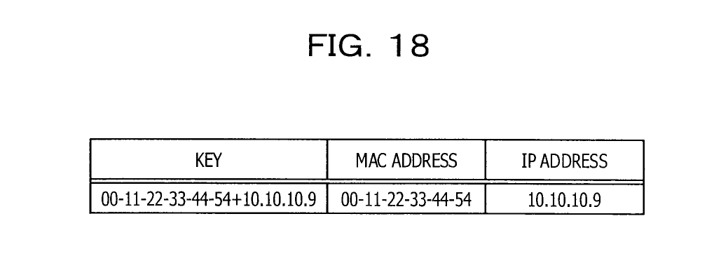

When, for example, the checked address list is the list illustrated in FIG. 17 and the assigned address list is the list illustrated in FIG. 5, the checked address list turns out to be one illustrated in FIG. 18 after completion of Step S63. In other words, the key and address of the device C remain in the checked address list.

On the other hand, when the address corresponding to the key generated in Step S59 is not included in the checked address list (Step S61: No route), the detection unit 105 instructs the check unit 106 to execute check processing. In response to this instruction, the check unit 106 executes the check processing (Step S65). The check processing is as described with reference to FIG. 8.

Then, based on the result of the check processing, the detection unit 105 determines whether or not the device having the address specified in Step S57 is to be managed (Step S67). When the device is not to be managed (Step S67: No route), the processing moves to Step S71.

On the other hand, when the device is to be managed (Step S67: Yes route), the detection unit 105 outputs the address specified in Step S57 to the DB management unit 107. Upon receipt of the specified address, the DB management unit 107 adds the received address to a management target address list stored in the target address storage unit 109 (Step S69). Then, the processing moves to Step S71.

The detection unit 105 adds the key generated in Step S59 and the address specified in Step S57 to the operation list stored in the operation list storage unit 110 (Step S71). Then, the processing returns to Step S55.

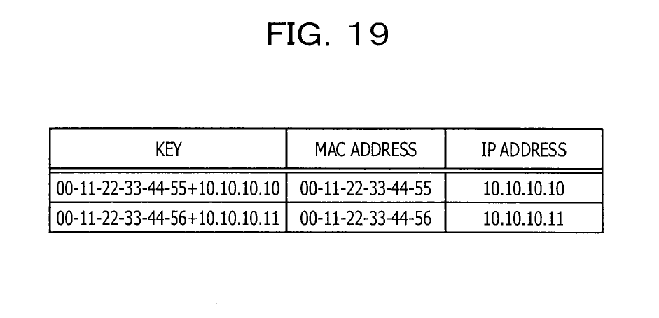

The operation list storage unit 110 stores an operation list as illustrated in FIG. 19, for example. In the example illustrated in FIG. 19, the operation list includes the key and address of the device A and the key and address of the device B.

When it is determined in Step S55 that the assigned address list includes no unprocessed address (Step S55: No route), the detection unit 105 deletes an address, which is included in both the management target address list and the checked address list, from the management target address list (Step S73).

The detection unit 105 replaces the address included in the checked address list with the address included in the operation list (Step S75), and stores the address in the checked address storage unit 108. Then, the processing returns to Step S51. As described above, the operation list created this time is used as the checked address list next time.

The execution of the processing as described above enables the detection unit 105 to perform processing using keys. Thus, the processing speed can be increased.

### Embodiment 3

Next, a third embodiment is described. In the second embodiment, the operation list storage unit 110 is provided to use keys. However, in the third embodiment, keys can be used without providing the operation list storage unit 110. Therefore, a functional block diagram of a management server 1 is the same as that of the management server 1 according to the first embodiment.

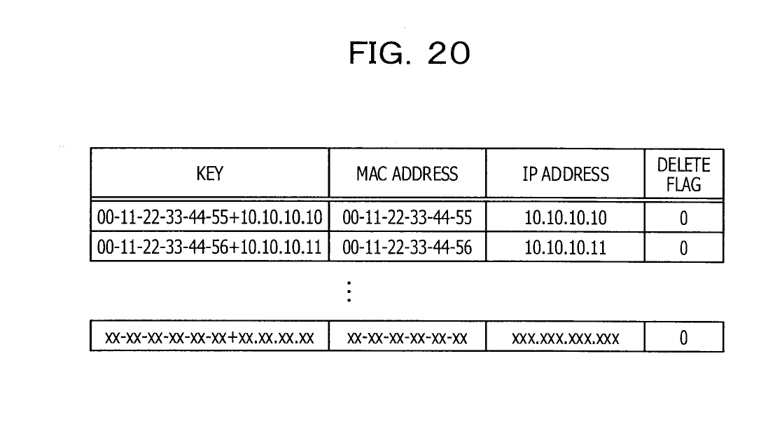

FIG. 20 illustrates an example of a checked address list stored in the checked address storage unit 108. In the example illustrated in FIG. 20, keys each including a MAC address and an IP address, MAC addresses, IP addresses and delete flags are stored. The key is generated from the MAC address and the IP address. The key and address having a delete flag “1” are those of a device that is uncoupled from the network 7. Note that other data to be used by the management unit 104 may be further stored.

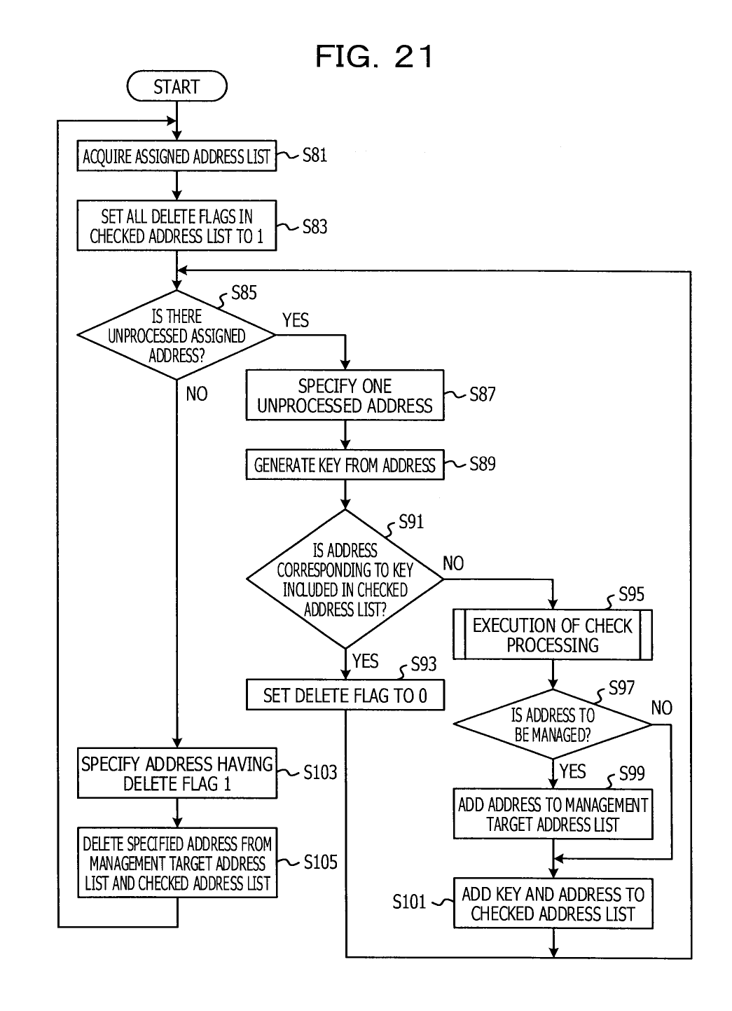

Next, with reference to FIGS. 21 to 25, description is given of processing executed by the management server 1. First, the detection unit 105 requests the DHCP processing unit 102 for an assigned address list periodically, for example, once every second. Then, the detection unit 105 acquires the assigned address list from the DHCP processing unit 102 (FIG. 21: Step S81). The assigned address list acquired in Step S81 is the list illustrated in FIG. 5, for example.

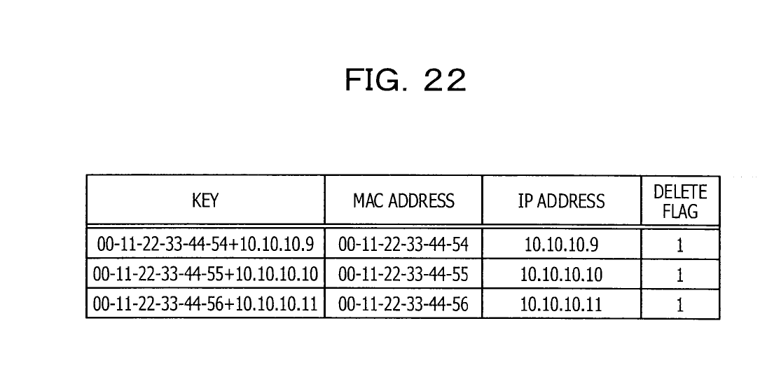

The detection unit 105 sets all the delete flags in the checked address list to 1 (Step S83). After the processing of Step S83, the checked address list turns out to be one illustrated in FIG. 22, for example. In the example illustrated in FIG. 22, the delete flags “1” are set to the keys and addresses of the devices A to C.

The detection unit 105 determines whether or not the assigned address list includes an unprocessed address (Step S85). Note that, when the processing of Step S85 is executed for the first time, the assigned address list includes no processed addresses. Also, the “address” in this processing means a set of a MAC address and an IP address.

When there are unprocessed addresses (Step S85: Yes route), the detection unit 105 specifies one unprocessed address (Step S87). Then, the detection unit 105 generates a key from a MAC address and an IP address, which are included in the specified address (Step S89). The key is generated by connecting the MAC address and the IP address, for example.

The detection unit 105 determines whether or not the address corresponding to the key generated in Step S89 is included in a checked address list (Step S91). The address not included in the checked address list is an address of a device newly coupled to the network 7, which is a new address. Note that, when the processing of Step S91 is executed for the first time, no addresses are included in the checked address list.

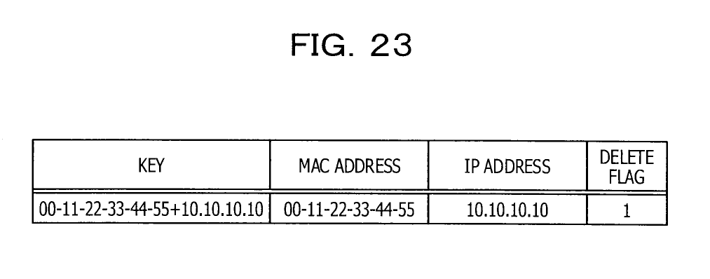

Here, it is assumed that a checked address list stored in the checked address storage unit 108 at the time point of Step S91 is a list illustrated in FIG. 23. More specifically, it is assumed that the address of the device A is stored in the checked address storage unit 108. In this case, the address of the device A from the two addresses illustrated in FIG. 5 is determined not to be a new address, and the address of the device B is determined to be a new address.

Also, it is assumed that a list illustrated in FIG. 22 is stored in the checked address storage unit 108. More specifically, it is assumed that the key and address of the device C, the key and address of the device A and the key and address of the device B are stored. It is also assumed that an assigned address list acquired this time is the list illustrated in FIG. 5. In this case, the device C is uncoupled from the network 7, while the devices A and B stay coupled to the network 7.

Referring back to FIG. 21, when the address corresponding to the key generated in Step S89 is included in the checked address list (Step S91: Yes route), the detection unit 105 sets the delete flag for the key generated in Step S89 to 0 (Step S93). Then, the processing returns to Step S85. Accordingly, the delete flag “1” is set for the key and address of the device uncoupled from the network 7.

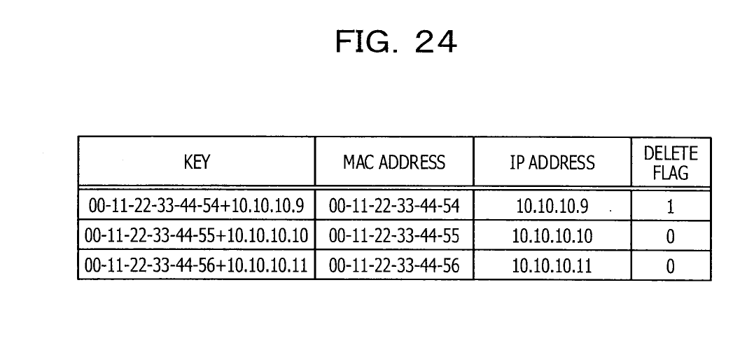

For example, it is assumed that the checked address list is the list illustrated in FIG. 22 and the assigned address list is the list illustrated in FIG. 5. In this case, the checked address list turns out to be one illustrated in FIG. 24 after completion of Step S93. Specifically, the delete flag “1” is set for the device C, while the delete flag “0” is set for each of the devices A and B.

On the other hand, when the address corresponding to the key generated in Step S89 is not included in the checked address list (Step S91: No route), the detection unit 105 instructs the check unit 106 to execute check processing. In response to this instruction, the check unit 106 executes the check processing (Step S95). The check processing is as described with reference to FIG. 8.

Then, based on the result of the check processing, the detection unit 105 determines whether or not the device having the address specified in Step S87 is to be managed (Step S97). When the device is not to be managed (Step S97: No route), the processing moves to Step S101.

On the other hand, when the device is to be managed (Step S97: Yes route), the detection unit 105 outputs the address specified in Step S87 to the DB management unit 107. Upon receipt of the specified address, the DB management unit 107 adds the received address to a management target address list stored in the target address storage unit 109 (Step S99). Then, the processing moves to Step S101.

The detection unit 105 adds the key generated in Step S89 and the address specified in Step S87 to the checked address list stored in the checked address storage unit 108 (Step S101). Then, the processing returns to Step S85.

When it is determined in Step S85 that the assigned address list includes no unprocessed address (Step S85: No route), the detection unit 105 specifies an address having the delete flag “1” set in the checked address list (Step S103).

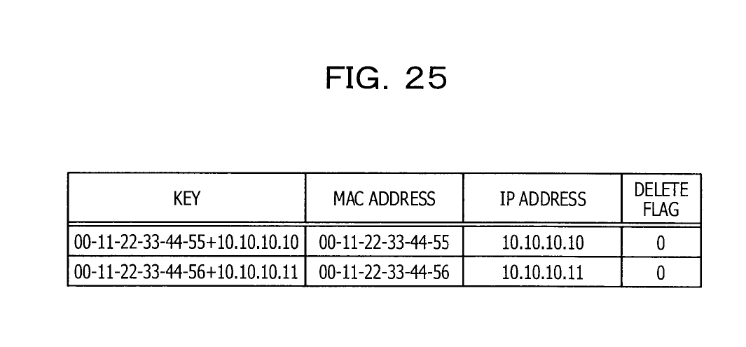

The detection unit 105 deletes the address specified in Step S103 from the management target address list and the checked address list (Step S105). Then, the processing returns to Step S81. For example, the checked address list illustrated in FIG. 24 turns out to be one illustrated in FIG. 25 after the execution of the processing of Steps S103 and S105. More specifically, the key and address of the device A and the key and address of the device B are stored in the checked address list. As described above, the keys and addresses of the devices coupled to the network 7 are stored in the checked address list.

The execution of the processing as described above enables the use of keys without providing the operation list storage unit 110 in the management server 1.

Although the embodiments of the present disclosure are described above, the present disclosure is not limited thereto. For example, the functional block configurations of the management server 1 described above may not coincide with an actual program module configuration.

Also, the configuration of each of the tables described above is an example, and the configurations of the tables do not have to be those described above. Moreover, in the processing flows, the processing order may be changed as long as the processing result is not changed. Furthermore, the processing may be performed in parallel.

The format of the key is not limited to that described above.

Note that the management server 1 described above is a computer device, in which a memory 2501, a central processing unit (CPU) 2503, a hard disk drive (HDD) 2505, a display control unit 2507 coupled to a display unit 2509, a drive unit 2513 for a removable disk 2511, an input unit 2515, and a communication control unit 2517 for connection to a network are coupled to each other through a bus 2519. An operating system (OS) and an application program for carrying out the processing in this example are stored in the HDD 2505, and are read into the memory 2501 from the HDD 2505 when executed by the CPU 2503. The CPU 2503 controls the display control unit 2507, the communication control unit 2517 and the drive unit 2513 according to processing contents of the application program to perform predetermined operations. Also, data that is being processed is mostly stored in the memory 2501, but may be stored in the HDD 2505. In the example of the present disclosure, the application program for carrying out the processing described above is stored in the computer-readable removable disk 2511 for distribution and is installed into the HDD 2505 from the drive unit 2513. Alternatively, the application program may be installed into the HDD 2505 through a network such as the Internet and the communication control unit 2517. In such a computer device, various functions as described above are realized by organized cooperation between the hardware such as the CPU 2503 and the memory 2501 and the programs such as the OS and the application program described above.

The embodiments of the present disclosure described above are summed up as follows.

A management apparatus according to a first aspect of the embodiment includes: (A) an acquisition unit configured to acquire identifiers of one or more devices coupled to a network; and (B) a detection unit configured to compare identifiers acquired by the acquisition unit at a first time point with identifiers acquired by the acquisition unit at a second time point prior to the first time point, and detect an identifier, which is not included in the identifiers acquired at the second time point, from among the identifiers acquired at the first time point.

Such a configuration enables simple detection of a device newly coupled to the network without introducing a special mechanism into the device.

The management apparatus further includes: (C) a determination unit configured to determine whether or not the first device is to be managed, based on data indicated by the identifier detected by the detection unit and acquired from the first device; and (D) a data management unit configured to add the identifier of the first device, when the first device is determined to be managed, to a data storage unit configured to store identifiers of devices to be managed. With such a configuration, management of the device indicated by the detected identifier can be started.

Also, the detection unit described above may (b1) detect an identifier not included in the identifiers acquired at the first time point, from among the identifiers acquired at the second time point, and delete one or more of the detected identifiers from the data storage unit, if the one or more detected identifiers are stored in the data storage unit. With such a configuration, only the identifier of the device to be managed can be stored in the data storage unit.

Moreover, the identifier described above may include an IP address and a MAC address. The detection unit described above may (b2) generate one key from the IP address and the MAC address and use the key as the identifier. When two identifiers, that is, the IP address and the MAC address are used, the detection processing may take time. Therefore, the use of one key generated from the IP address and the MAC address can reduce the time for the detection processing.

Furthermore, the acquisition unit described above may (a1) perform DHCP processing. The use of a DHCP enables simple acquisition of identifiers.

A management method according to the first aspect of the embodiment includes: (E) acquiring identifiers of one or more devices coupled to a network at a first time point; (F) acquiring identifiers of one or more devices coupled to the network at a second time point after the first time point; and (G) comparing the identifiers acquired at the first time point with the identifiers acquired at the second time point, and detecting an identifier not included in the identifiers acquired at the second time point, from among the identifiers acquired at the first time point.

Note that a program can be created to allow a computer to perform processing by the method described above. The program is stored in a flexible disk, a CD-ROM, a magneto-optical disk, a semiconductor memory, a computer-readable storage medium such as a hard disk or a storage unit. Note that an intermediate processing result is temporarily stored in a storage unit such as a main memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor coupled to the memory and configured to
acquire a first identifier indicating a device coupled to a network at a first time point,
acquire a second identifier indicating a device coupled to the network at a second time point after the first time point, and
determine whether or not the second identifier is identical to the first identifier.

2. The information processing apparatus according to claim 1, wherein the processor is configured to
create a first identifier list including one or more first identifiers indicating one or more devices coupled to the network at the first time point,
create a second identifier list including one or more second identifiers indicating one or more devices coupled to the network at the second time point, and
when any of the second identifiers included in the second identifier list is not included in the first identifier list, determine whether or not the device indicated by the second identifier is to be managed.

3. The information processing apparatus according to claim 2, wherein the processor is configured to
transmit a first data to the device indicated by the second identifier,
when there is no response to the first data, determine that the device indicated by the second identifier is not to be managed, and
when there is a response to the first data, determine based on a content of the response whether or not the device indicated by the second identifier is to be managed.

4. The information processing apparatus according to claim 2, wherein the processor is configured to
when any one of the first identifiers included in the first identifier list is not included in the second identifier list, determine that a device indicated by the first identifier is not to be managed.

5. The information processing apparatus according to claim 1, wherein
the first identifier includes a first Internet Protocol address and a first Media Access Control address of the device indicated by the first identifier, and
the second identifier includes a second Internet Protocol address and a second Media Access Control address of the device indicated by the second identifier.

6. The information processing apparatus according to claim 1, wherein
the first identifier is generated based on a first Internet Protocol address and a first Media Access Control address of the device indicated by the first identifier, and
the second identifier is generated based on a second Internet Protocol address and a second Media Access Control address of the device indicated by the second identifier.

7. The information processing apparatus according to claim 1, wherein the processor is configured to execute a Dynamic Host Configuration Protocol.

8. The information processing apparatus according to claim 1, wherein the processor is configured to acquire an identifier of a device coupled to the network at a predetermined time interval.

9. An information processing method comprising:
acquiring a first identifier indicating a device coupled to a network at a first time point;
acquiring a second identifier indicating a device coupled to the network at a second time point after the first time point; and
determining whether or not the second identifier is identical to the first identifier.

10. The information processing method according to claim 9, further comprising:
creating a first identifier list including one or more first identifiers indicating one or more devices coupled to the network at the first time point;
creating a second identifier list including one or more second identifiers indicating one or more devices coupled to the network at the second time point; and
when any of the second identifiers included in the second identifier list is not included in the first identifier list, determining whether or not the device indicated by the second identifier is to be managed.

11. The information processing method according to claim 10, further comprising:
transmitting a first data to the device indicated by the second identifier;
when there is no response to the first data, determining that the device indicated by the second identifier is not to be managed; and
when there is a response to the first data, determining based on a content of the response whether or not the device indicated by the second identifier is to be managed.

12. The information processing method according to claim 10, further comprising:
when any one of the first identifiers included in the first identifier list is not included in the second identifier list, determining that a device indicated by the first identifier is not to be managed.

13. The information processing method according to claim 9, wherein
the first identifier includes a first Internet Protocol address and a first Media Access Control address of the device indicated by the first identifier, and
the second identifier includes a second Internet Protocol address and a second Media Access Control address of the device indicated by the second identifier.

14. The information processing method according to claim 9, wherein
the first identifier is generated based on a first Internet Protocol address and a first Media Access Control address of the device indicated by the first identifier, and
the second identifier is generated based on a second Internet Protocol address and a second Media Access Control address of the device indicated by the second identifier.

15. The information processing method according to claim 9, further comprising:
executing a Dynamic Host Configuration Protocol.

16. The information processing method according to claim 9, the acquiring of an identifier of a device coupled to the network is executed at a predetermined time interval.

17. An information processing system comprising:
a plurality of devices; and
an information processing apparatus coupled to a network and including a memory and a processor coupled to the memory and configured to
acquire a first identifier indicating a device included in the plurality of devices coupled to the network at a first time point,
acquire a second identifier indicating a device included in the plurality of devices coupled to the network at a second time point after the first time point, and
determine whether or not the second identifier is identical to the first identifier.

18. The information processing system according to claim 17, wherein the processor is configured to
create a first identifier list including one or more first identifiers indicating one or more devices coupled to the network at the first time point,
create a second identifier list including one or more second identifiers indicating one or more devices coupled to the network at the second time point, and
when any of the second identifiers included in the second identifier list is not included in the first identifier list, determine whether or not the device indicated by the second identifier is to be managed.

19. The information processing system according to claim 18, wherein the processor is configured to
transmit a first data to the device indicated by the second identifier,
when there is no response to the first data, determine that the device indicated by the second identifier is not to be managed, and
when there is a response to the first data, determine based on a content of the response whether or not the device indicated by the second identifier is to be managed.

20. The information processing system according to claim 18, wherein the processor is configured to
when any one of the first identifiers included in the first identifier list is not included in the second identifier list, determine that a device indicated by the first identifier is not to be managed.
